(19) United States
(12) Patent Application Publication
(10) Pub. No.: US 2023/0416420 A1
(43) Pub. Date: Dec. 28, 2023

(54) Method Of Preparing Functional Polymers

(71) Applicant: Merichem Company, Houston, TX (US)

(72) Inventors: Zhouyang Liu, Houston, TX (US); Nachiketa Anand, Houston, TX (US)

(73) Assignee: Merichem Company, Houston, TX (US)

(21) Appl. No.: 17/851,523

(22) Filed: Jun. 28, 2022

(51) Int. Cl. C08F 10/06; D01F 6/06; C08F 2/50

(52) U.S. Cl. CPC C08F 10/06; D01F 6/06; C08F 2/50; D10B 2321/022

(57) ABSTRACT

An apparatus may include: a flow path defined by a conduit; and a functional polymer disposed in the conduit, wherein the functional polymer comprises a polymer and a macrocycle, wherein the macrocycle is grafted to the polymer by an amide bond formed between the macrocycle and the polymer.

### BACKGROUND

Chemical processes often require multiple unit operations to produce a product stream. A particular unit operation may be a liquid-liquid contacting operation whereby two liquids are brought into intimate contact to effectuate mass transfer between the liquids, a reaction between components in the liquids, or both. Another unit operation may be a gas-liquid contacting operation whereby a gas and a liquid are brought in contact to effectuate mass transfer between the liquids, a reaction between components in the liquids, or both. Liquid-liquid contacting may be beneficial in some types of chemical reactions where one reactant is miscible in a first liquid but immiscible in a second liquid. An example of such a reaction may be where a first reactant is present in a polar solvent such as water and a second reactant is present in a non-polar solvent such as a hydrocarbon and the water and hydrocarbon are immiscible. Liquid-liquid contacting may have other applications such as liquid-liquid extraction whereby a species present in a first liquid is extracted into a second liquid by mass transfer across the liquid-liquid interface. Gas-liquid contacting may be beneficial in some types of chemical reactions where a component in the gas phase is to be reacted with a component in the liquid phase of where a gaseous component is absorbed into the liquid phase.

A particular challenge of liquid-liquid contactors and gas-liquid contactors, collectively referred to as “mass transfer devices”, may be ensuring adequate contact area between phases such that the mass transfer or reactions may occur in an appreciable amount and in an economically viable manner. In general, liquid-liquid contacting operations may be performed with immiscible liquids, such as, for example, an aqueous liquid and an organic liquid. Using two immiscible liquids may allow the liquids to be readily separated after the liquid-liquid contacting is completed. However, when a liquid-liquid contacting operation is performed with immiscible liquids, phase separation may occur before adequate contact between the liquids is achieved.

Several mass transfer devices and techniques have been developed to enhance the contact area between phases, including, but not limited to, fiber-bundle type contactors. A fiber-bundle type contactor may generally comprise one or more fiber bundles suspended within a shell and two or more inlets where the phases, including gas-liquid or liquid-liquid, may be introduced into the shell. The fiber bundle may promote contact between the phases by allowing a first phase to flow along individual fibers of the fiber bundles and a second phase to flow between the individual fibers thereby increasing the effective contact area between the phases. The two phases may flow from an inlet section of the shell to an outlet section of the shell while maintaining intimate contact such that a reaction, mass transfer, or both may be maintained between the two phases.

Fiber-bundle type contactors have been developed to teat mercaptan sulfur containing hydrocarbon streams. In these contactors, a liquid catalyst or solid catalyst bed may be utilized in conjunction with caustic to convert mercaptan sulfur to disulfide oil. However, there exist challenges in this process including ensuring that the extent of reaction is sufficient to such that the resultant product stream is on specification. Some methods to ensure that the extent of reaction are sufficient to produce a product stream that is on specification may be to design the mass transfer device to have longer contact time by building the mass transfer device physically larger or to design the mass transfer device with features that enhance mixing from entrance effects. While physical features of the mass transfer device may be optimized to some degree, there may be limitations to the extent to which a reaction may proceed regardless of the physical configuration of the mass transfer device because of limitations of the oxidation catalyst.

### SUMMARY

Disclosed herein is an example method of producing a functional polymer comprising: providing a polymer comprising carboxyl groups on a surface of the polymer and a macrocycle comprising an amine on a surface of the macrocycle; mixing the polymer and the macrocycle; and reacting the polymer and the macrocycle to form an amide bond between the polymer and the macrocycle thereby forming the functional polymer.

Further disclosed herein is an example method of producing a functional polymer comprising: providing a polymer comprising an amine group on a surface of the polymer and a macrocycle comprising a carboxyl group on a surface of the macrocycle; mixing the polymer and the macrocycle; and reacting the polymer and the macrocycle to form an amide bond between the polymer and the macrocycle thereby forming the functional polymer.

Further disclosed herein is an example method comprising: introducing into a fiber bundle contactor a hydrocarbon comprising mercaptan sulfur, an aqueous caustic solution, and an oxidizer, wherein the fiber bundle contactor comprises a flow path defined by a conduit, a functional polymer disposed in the conduit, and an inlet allowing fluid flow into the flow path, wherein the functional polymer comprises a polymer and a macrocycle grafted to the polymer; reacting at least a portion of the mercaptan sulfur and the aqueous caustic solution to produce a mercaptide; and reacting the mercaptide and the oxidizer in the presence of the functional polymer to produce a disulfide oil.

Further disclosed herein is an example method comprising: providing a functional polymer comprising a polymer and a macrocycle grafted to the polymer; contacting the functional polymer with a solution comprising metal ions; and adsorbing at least a portion of the metal ions with the functional polymer.

Further disclosed herein is an example of a functional polymer comprising: a polymer; and a macrocycle, wherein the macrocycle is grafted to the polymer by an amide bond formed between the macrocycle and the polymer.

Further disclosed herein is an apparatus comprising: a flow path defined by a conduit; and a functional polymer disposed in the conduit, wherein the functional polymer comprises a polymer and a macrocycle, wherein the macrocycle is grafted to the polymer by an amide bond formed between the macrocycle and the polymer.

These and other features and attributes of the disclosed processes and systems of the present disclosure and their advantageous applications and/or uses will be apparent from the detailed description which follows.

### BRIEF DESCRIPTION OF THE DRAWINGS

These drawings illustrate certain aspects of some of the embodiments of the present disclosure, and should not be used to limit or define the disclosure.

FIG. 1 is a block flow diagram of a process for producing disulfide oil from a hydrocarbon stream containing mercaptan sulfur.

FIG. 2 illustrates a hydrocarbon desulfurization vessel containing functional polymers.

FIG. 3 illustrates a hydrocarbon desulfurization vessel containing functional polymers.

FIG. 4 illustrates a hydrocarbon desulfurization vessel containing functional polymers.

FIG. 5 illustrates a standalone caustic regeneration unit containing functional polymers.

FIG. 6 illustrates a standalone caustic regeneration unit containing functional polymers.

FIG. 7a illustrates a standalone caustic regeneration unit containing functional polymers

FIG. 7b illustrates a top view of a distributor tray.

### DETAILED DESCRIPTION

The present disclosure may relate to preparation of functional polymers. Functional polymers may be prepared by chemically grafting a macrocycle to a surface of a polymer by formation of an amide bond between the macrocycle and the polymer. Polymers may be shaped into articles such as films, fibers, and woven materials where the article retains the functionality imparted by the macrocycle grafted to the polymer. In one embodiment, the functional polymers may be drawn into a fiber bundle. In further embodiments, a fiber bundle comprising the functional polymer may be included in a mass transfer device such as a liquid-liquid or a gas-liquid contactor. A method may include using the functional polymers to catalyze a reaction such as mercaptan oxidation. A further method may include using the functional polymers to selectively remove metal ions from solution.

In general, the functional polymers may be prepared by reacting a polymer with a macrocycle under conditions suitable to form a covalent bond between the polymer and the macrocycle. The polymer may contain functional groups disposed on the surface of the polymer which are able to react with functional groups in the macrocycle to form a covalent bond thereby grafting the macrocycle to the polymer. In embodiments, the polymer may naturally contain functional groups suitable for reacting with the macrocycle. In some embodiments, the polymer may be treated such that reactive groups are disposed on the surface of the polymer. The treated polymer may then be reacted with the macrocycle under conditions suitable to graft the macrocycle to the treated polymer.

Polymers suitable for the present application include, without limitation, polysaccharides, polyisoprenes, polyamides, aromatic polyamides, polyesters, polyolefins, polychloroprenes, synthetic polyisoprenes, polybutadienes, and copolymer rubbers such as butyl rubbers, styrene butadiene rubbers, and nitrile rubbers, for example. While not wishing to be limited by theory, it is believed that any polymer which contains a carboxyl group or could be modified to include a carboxyl group can be utilized in the present application. Some specific polymers suitable for the present application include, without limitation, cellulose, natural rubber, wool, polyester, polyethylene, polypropylene, polystyrene, neoprene, and nylon, for example.

Macrocycles suitable for use in the present application may include, but are not limited to, porphyrin and derivatives thereof, phthalocyanine macrocycles and derivatives thereof, crown ethers and derivatives thereof such as aza substituted crown ethers and derivatives thereof, polyaza macrocycles and derivatives thereof, polythia macrocycles and derivatives thereof, polyphospha macrocycles and derivatives thereof, and polypyridone macrocycles and derivatives thereof. While not wishing to be limited by theory, it is believed that any macrocycle which contains an amine group and/or a carboxyl group or could be modified to include an amine group and/or a carboxyl group can be utilized in the present application. In some embodiments, the macrocycle includes one or more amine groups (—NH₂ or —NH) and/or carboxyl (—COOH) groups grafted to the macrocycle.

In some embodiments, suitable macrocycles may contain functional groups which can be reacted to form amine groups (—NH₂ or —NH) and/or carboxyl (—COOH) groups on the macrocycle. Reaction 1 illustrates an embodiment where 1,10-benzene-8,17-bromo-tetra-azamacrocycle is reacted to form the corresponding carboxylic acid. Reaction 2 illustrates an embodiment where 1,10-benzene-8,17-bromo-tetra-azamacrocycle is reacted to form the corresponding amine.

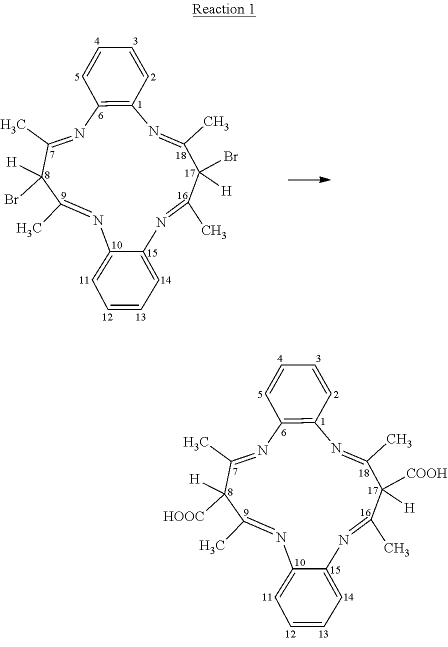 [SMILES: C/C1=N\c2ccccc2/N=C(\C)C(Br)/C(C)=N/c2ccccc2/N=C(\C)C1Br ; C/C1=N\c2ccccc2/N=C(\C)C(C(=O)O)/C(C)=N/c2ccccc2/N=C(\C)C1C(=O)O]

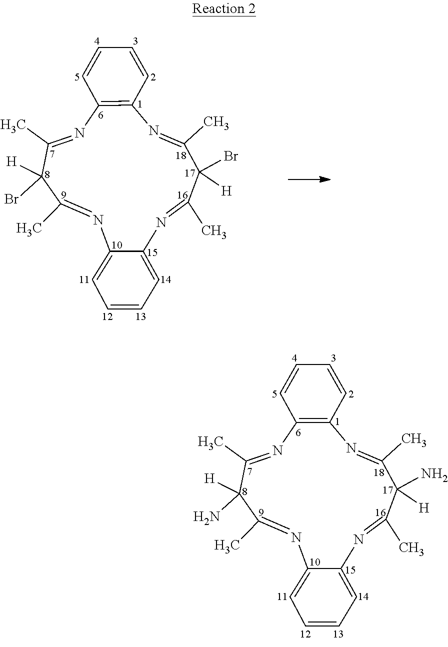 [SMILES: C/C1=N\c2ccccc2/N=C(\C)C(Br)/C(C)=N/c2ccccc2/N=C(\C)C1Br ; C/C1=N\c2ccccc2/N=C(\C)C(N)/C(C)=N/c2ccccc2/N=C(\C)C1N]

In further embodiments, the macrocycle may include an amine containing compound grafted to the macrocycle. Amine containing compounds may include amines with a carbon number in a range C2-C20, including monoamines, diamines, triamines, and higher order amines. The amine containing compound may include linear, branched, or cyclic amines. Some specific amine containing compounds may include, without limitation, ethylenediamine, propane-1,3-diamine, butane-1,4-diamine, pentane-1,5-diamine, hexamethylenediamine, diethylenetriamine, benzene-1,3,5-triamine, aniline, and combinations thereof. In further embodiments, the macrocycle may include a carboxyl containing compound grafted to the macrocycle. Carboxyl containing compounds may have a carbon number in a range C2-C20. The carboxyl containing compounds may include linear, branched, or cyclic compounds.

Macrocycles may further include one or more substituted groups grafted to the macrocycle to replace one or more groups, such as hydrogen, halogen, or other leaving group, on the macrocycle. Some non-limiting examples of substitutions may include substitutions of halogens, hydroxyl, alkyl, aryl, thiol, alkoxy, nitrosyl groups, phenyl groups, or combinations thereof. Macrocycles may include a metal that form a coordination complex with the macrocycle including, without limitation, vanadium (V), manganese (Mn), iron (Fe), cobalt (Co), nickel (Ni), copper (Cu), zinc (Zn), ruthenium (Ru), rhodium (Rh), palladium (Pd), silver (Ag), and combinations thereof.

Some suitable macrocycles may include metal phthalocyanines substituted with one or more amine and/or carboxyl groups such as mono and poly amino metal phthalocyanines and mono and poly carboxyl metal phthalocyanines. Some specific suitable metal phthalocyanines include, without limitation, tetra-amino cobalt (II) phthalocyanine shown in Structure 1 and tetra-carboxylic acid cobalt (II) phthalocyanine shown in Structure 2.

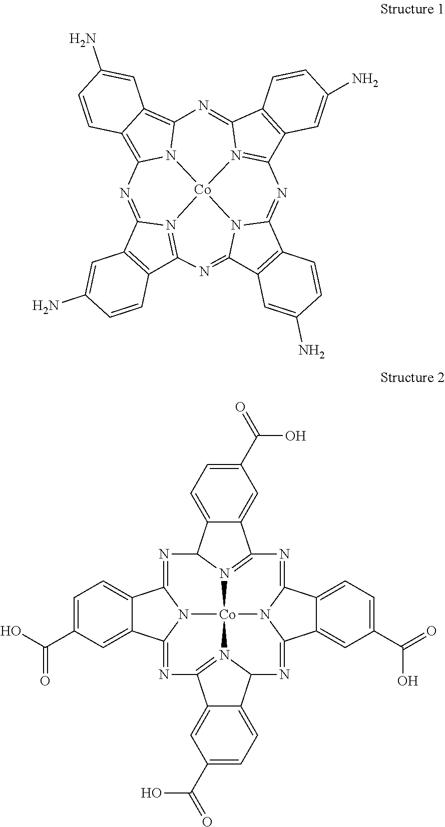

Another suitable macrocycle includes polypyridone macrocycles and derivatives thereof such as trimers and higher order oligomers of pyridone. One specific suitable polypyridone includes, without limitation, macrocyclic pyridine pentamer of Structure 3.

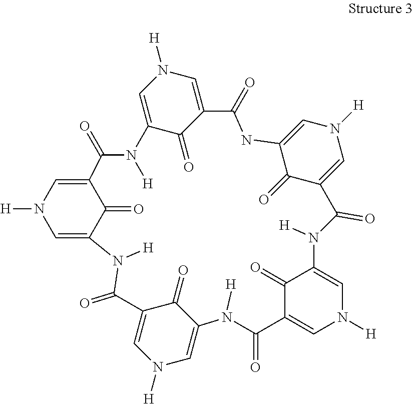 [SMILES: O=C1Nc2c[nH]cc(c2=O)C(=O)Nc2c[nH]cc(c2=O)C(=O)Nc2c[nH]cc(c2=O)C(=O)Nc2c[nH]cc(c2=O)C(=O)Nc2c[nH]cc1c2=O]

Another suitable macrocycle includes amine and carboxyl substituted crown ethers and derivatives thereof. Some specific suitable substituted crown ethers include, without limitation, derivatives of 18-crown-6 such as aminobenzo-18-crown-6 of Structure 4 and 2-aminomethyl-18-crown-6 of Structure 5. Suitable macrocycles may further include aza substituted crown ethers whereby one or more oxygens in the crown ether is replaced by (—NH) such as the polyoxaaza macrocycle of Structure 6.

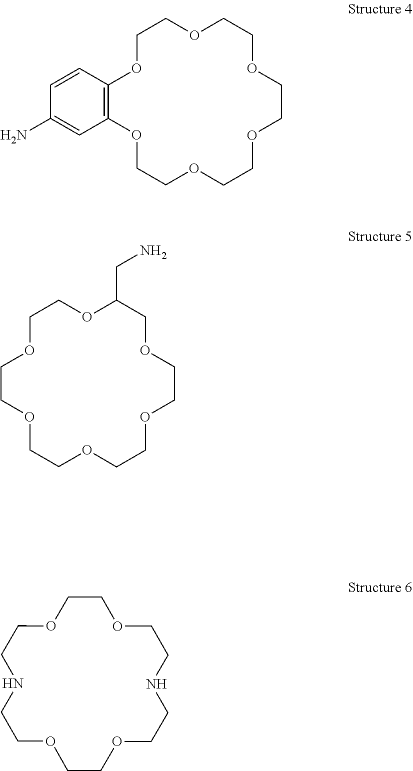 [SMILES: Nc1ccc2c(c1)OCCOCCOCCOCCOCCO2 ; NCC1COCCOCCOCCOCCOCCO1 ; C1COCCOCCNCCOCCOCCN1]

Another suitable macrocycle includes polyaza macrocycles such as cyclam in Structure 7.

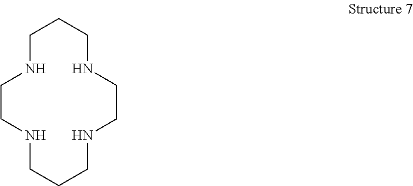 [SMILES: C1CNCCNCCCNCCNC1]

Another suitable macrocycle incudes mixed donor macrocycles which contain two or more substituent components selected from polyaza, polyoxaaza, polyether, polythia, and polyphospha. Mixed donor macrocycles may include substitutions such as halogens, hydroxyl, alkyl, aryl, thiol, alkoxy, nitrosyl groups, phenyl groups, or combinations thereof An example of a mixed donor macrocycle is shown in Structure 8.

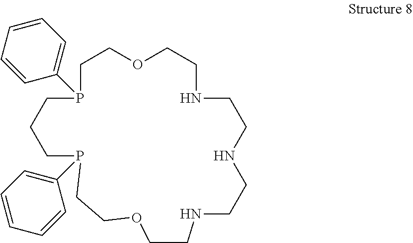 [SMILES: c1ccc(P2CCCP(c3ccccc3)CCOCCNCCNCCNCCOCC2)cc1]

In some embodiments, the polymer may be oxidized to introduce carboxyl groups to the surface of the polymer. Some suitable methods for introducing carboxyl groups include, without limitation, gamma-radiation treatment, plasma treatment, UV treatment, or chemical oxidation. Polymer oxidation may be carried out in a liquid or gas environment to form carboxyl functional groups on the surface of the polymer. The step of oxidizing may oxidize the polymer to any suitable extent. The degree of oxidation may be utilized to control the final concentration macrocycle dispersed on the polymer which may in turn directly affect the overall catalytic activity of the polymer.

Oxidation of the polymer may be achieved by submersing the polymer in an acid and allowing the acid to react with the polymer. Suitable acids may include, but are not limited to, mineral acids such as hydrochloric acid, nitric acid, phosphoric acid, sulfuric acid, boric acid, hydrofluoric acid, hydrobromic acid, perchloric acid, hydroiodic acid, fluoroantimonic acid, carborane acids, fluoroboric acid, fluorosulfuric acid, hydrogen fluoride, triflic acid, and perchloric acid for example organic acids such as acetic acid, formic acid, citric acid, oxalic acid, and tartaric acid, for example. Oxidizing agents can be used alone or with an acid to oxidize the polymer. Suitable oxidizing agents include, without limitation, ozone, hydrogen peroxide, sodium hypochlorite, permanganate, potassium chromate, potassium dichromate, chlorine dioxide, and transition metal nitrates, for example.

In addition to, or alternatively to oxidation using acids, the oxidation step may also be performed using plasma treatment in oxygen atmosphere, gamma radiation treatment, electrochemical oxidation using an oxidant such as sodium hydroxide, ammonium hydrogen carbonate, ammonium carbonate, sulfuric acid, or nitric acid, or oxidation by potassium persulfate with sodium hydroxide or silver nitrate. The acidic oxidation may be performed at any temperature in the range of about 0° C. to 150° C. Alternatively, the oxidation may be performed in a range of 0° C. to about 25° C., about 25° C. to about 50° C., about 50° C. to about 75° C., about 75° C. to about 100° C., about 100° C. to about 125° C., about 125° C. to about 150° C. or any temperature ranges therebetween. Oxidation may be performed for any period of time suitable for achieving a desired concentration of oxygen-containing functional groups on the polymer. The time required to achieve a specified concentration of oxygen-containing functional groups may be dependent upon many factors including identity and concentration of the acid and temperature conditions selected.

In general, the oxidation may be carried out for a period of time ranging from about 1 hour to about 24 hours. Alternatively, the oxidation may be carried out in a time ranging from about 1 hour to about 3 hours, about 3 hours to about 6 hours, about 6 hours to about 9 hours, about 9 hours to about 12 hour, about 12 hours to about 15 hours, about 15 hours to about 18 hours, about 18 hours to about 21 hours, about 21 hours to about 24 hours, or any ranges therebetween. After oxidation by acid treatment, the oxidized polymer may optionally be washed using water or other solvent to remove excess acid. The oxidized polymer may be dried at elevated temperature after washing to remove water or solvent used in the washing step.

In general, the functional polymers may be prepared by reacting a polymer with a macrocycle under conditions suitable to form an amide bond between the polymer and the macrocycle by reacting a carboxyl group with an amine group. In some embodiments, the carboxyl group is present on the polymer and the amine group is preset on the macrocycle. Alternatively, the carboxyl group may be present on the macrocycle and the amine group may be present on the polymer. There are several synthesis methods for formation of an amide bond between the polymer and the macrocycle, only some of which may be disclosed herein. One synthesis method may include direct formation of the amide bond by reacting the polymer and macrocycle at elevated temperature in a suitable solvent. Another synthesis method may include amide formation via the generation of acyl chlorides from carboxyl groups with chlorinating agents such as thionyl chloride. Another synthesis method may include amide formation using a coupling agent such as carbodiimide or benzotriazole. Another synthesis method may include enzyme catalyzed amide formation.

In the direct amide bond synthesis, polymer and macrocycle may be combined in a solvent and heated thereby forming an amide bond between the polymer and macrocycle to produce the functional polymer Some suitable solvents may include, but are not limited to pyridine, DMSO, DMF, THF, ethanol, acetonitrile, chloroform, ethylene glycol, methanol, benzene, and combinations thereof. The polymer may be reacted with the macrocycle at any suitable conditions, including at a temperature in the range of about 100° C. to 200° C. Alternatively, the reaction may be performed in a range of 100° C. to about 125° C., about 125° C. to about 150° C., about 150° C. to about 175° C., about 175° C. to about 200° C., or any temperature ranges therebetween. The time required for reacting the polymer and macrocycle may be dependent upon many factors including identity of the macrocycle and temperature conditions selected. In general, the polymer may be reacted with the macrocycle for a period of time ranging from about 1 hour to about 24 hours or longer. Alternatively, the reaction may be carried out in a time ranging from about 1 hour to about 3 hours, about 3 hours to about 6 hours, about 6 hours to about 9 hours, about 9 hours to about 12 hour, about 12 hours to about 15 hours, about 15 hours to about 18 hours, about 18 hours to about 21 hours, about 21 hours to about 24 hours, or any ranges therebetween. After the macrocycle reaction, the functional polymer may optionally be washed using water or other solvent to remove excess macrocycle. The functional polymer may be dried at elevated temperature after washing to remove water or solvent used in the washing step.

In the acyl chloride synthesis, polymer may be combined with a chlorinating agent such as thionyl chloride, phosphorous trichloride, or terephthaloyl chloride, and heated. The chlorinating agent may react with oxygen containing groups, such as carboxyl groups, on the polymer to produce acyl chloride on the polymer. The polymers may be reacted with the chlorinating agent at any suitable conditions below the boiling point of the chlorinating agent, including at a temperature in the range of about 0° C. to 150° C. Alternatively, the reaction may be performed in a range of 0° C. to about 25° C., about 25° C. to about 50° C., about 50° C. to about 75° C., about 75° C. to about 100° C., about 100° C. to about 125° C., about 125° C. to about 150° C. or any temperature ranges therebetween. In general, the polymer may be reacted with the chlorinating agent for a period of time ranging from about 1 hour to about 24 hours or longer. The chlorinating agent modified polymers may be reacted with an aminated macrocycle to produce a functional polymer. For example, the chlorinating agent modified polymers and aminated macrocycle may be combined in a solvent and heated thereby forming an amine bond between the polymer and macrocycle to produce the functional polymer. Some suitable solvents may include, but are not limited to water, pyridine, DMSO, DMF, THF, ethanol, acetonitrile, chloroform, ethylene glycol, methanol, benzene, and combinations thereof. The chlorinating agent modified polymers may be reacted with the macrocycle at any suitable conditions, including at a temperature in the range of about 0° C. to 150° C. Alternatively, the reaction may be performed in a range of 0° C. to about 25° C., about 25° C. to about 50° C., about 50° C. to about 75° C., about 75° C. to about 100° C., about 100° C. to about 125° C., about 125° C. to about 150° C. or any temperature ranges therebetween. The time required for reacting the chlorinating agent modified polymers and macrocycle may be dependent upon many factors including identity of aminated macrocycle and temperature conditions selected. In general, the chlorinating agent modified polymers may be reacted with the macrocycle for a period of time ranging from about 1 hour to about 24 hours or longer. Alternatively, the reaction may be carried out in a time ranging from about 1 hour to about 3 hours, about 3 hours to about 6 hours, about 6 hours to about 9 hours, about 9 hours to about 12 hour, about 12 hours to about 15 hours, about 15 hours to about 18 hours, about 18 hours to about 21 hours, about 21 hours to about 24 hours, or any ranges therebetween. After the macrocycle reaction, the functional polymer may optionally be washed using water or other solvent to remove excess macrocycle. The functional polymer may be dried at elevated temperature after washing to remove water or solvent used in the washing step.

Another synthesis method may include amide formation using a coupling agent. In this method, polymer and a coupling agent may be combined in a suitable solvent and heated. The coupling agent may react with oxygen-containing functional groups on the polymer or with the polymer to form a coupling agent modified polymer. Some suitable coupling agents may include, but are not limited to carbodiimide, benzotriazole, and combinations thereof. The coupling agent modified polymer may be combined with a macrocycle and solvent which may react to form the functional polymer. Some suitable solvents may include, but are not limited to water, pyridine, DMSO, DMF, THF, ethanol, acetonitrile, chloroform, ethylene glycol, methanol, benzene, and combinations thereof. The coupling agent modified polymer may be reacted with the macrocycle at any suitable conditions, including at a temperature in the range of about 0° C. to 150° C. Alternatively, the reaction may be performed in a range of 0° C. to about 25° C., about 25° C. to about 50° C., about 50° C. to about 75° C., about 75° C. to about 100° C., about 100° C. to about 125° C., about 125° C. to about 150° C. or any temperature ranges therebetween. The time required for reacting the coupling agent modified polymer and macrocycle may be dependent upon many factors including identity of the macrocycle and temperature conditions selected. In general, the coupling agent modified polymer may be reacted with the macrocycle for a period of time ranging from about 1 hour to about 24 hours or longer. Alternatively, the reaction may be carried out in a time ranging from about 1 hour to about 3 hours, about 3 hours to about 6 hours, about 6 hours to about 9 hours, about 9 hours to about 12 hour, about 12 hours to about 15 hours, about 15 hours to about 18 hours, about 18 hours to about 21 hours, about 21 hours to about 24 hours, or any ranges therebetween. After the macrocycle reaction, the functional polymer may optionally be washed using water or other solvent to remove excess macrocycle. The functional polymer may be dried at elevated temperature after washing to remove water or solvent used in the washing step.

Another synthesis method may include amide formation using an enzyme. Enzymatic catalysis may allow for the amination reaction to occur at relatively lower temperatures which may allow for a broader solvent compatibility. In this method, polymer and macrocycle may be combined in a in a suitable solvent with an enzyme. The enzyme may include any enzyme capable of catalyzing the formation of an amide bond between the polymer and the animated macrocycle. Some examples of suitable enzymes may include, but are not limited to, proteases, subtilisin, acylases, amidases lipases, and combinations thereof. Some suitable solvents may include, but are not limited to water, pyridine, DMSO, DMF, THF, ethanol, acetonitrile, chloroform, ethylene glycol, methanol, benzene, and combinations thereof. The polymer may be reacted with the aminated macrocycle at any suitable conditions, including at a temperature in the range of about 0° C. to 100° C. Alternatively, the reaction may be performed in a range of 0° C. to about 25° C., about 25° C. to about 50° C., about 50° C. to about 75° C., about 75° C. to about 100° C., or any temperature ranges therebetween. The time required for reacting the polymer and macrocycle may be dependent upon many factors including identity of the macrocycle and temperature conditions selected. In general, the polymer may be reacted with the macrocycle for a period of time ranging from about 1 hour to about 24 hours or longer. Alternatively, the reaction may be carried out in a time ranging from about 1 hour to about 3 hours, about 3 hours to about 6 hours, about 6 hours to about 9 hours, about 9 hours to about 12 hour, about 12 hours to about 15 hours, about 15 hours to about 18 hours, about 18 hours to about 21 hours, about 21 hours to about 24 hours, or any ranges therebetween. After the macrocycle reaction, the functional polymer may optionally be washed using water or other solvent to remove excess macrocycle. The functional polymer may be dried at elevated temperature after washing to remove water or solvent used in the washing step.

The functional polymers may have various shapes and forms including, but not limited to, thin films, stable fibers, continuous fibers, yarns, and woven polymer, for example. Once the functional polymers have been synthesized as described above, the functional polymers may be further processed by shaping the functional polymers. For example, individual strands of the functional polymers may be drawn together and secured to form a functional polymer bundle, a yarn, or a woven polymer. The functional polymer may be shaped to form pellets or other shapes suitable for use as packing in a packed column, as a packing in an adsorbent bed or pad, or a shape suitable for a fluidized bed reactor. The functional polymer can be included in reactors and mass transfer devices to catalyze reactions and/or facilitate mass transfer between phases.

In one embodiment, the functional polymer is used as an adsorbent such as in a filter or adsorbent bed to selectively remove metal ions from a solution. A solution containing metal ions may be passed through an adsorbent bed comprising the functional polymer and at least a portion of the metal ions may be removed from the solution by the functional polymer. Some examples of functional polymers which may be suitable for adsorbent beds include crown ethers and derivatives thereof such as aza substituted crown ethers, polyaza macrocycles and derivatives thereof. Some examples of metal which may be removed by the functional polymers include, but are not limited to, chromium, cobalt, lead, arsenic, nickel, zinc, cadmium, mercury, copper, and combinations thereof.

In another embodiment, the functional polymer is used as a catalyst and mass transfer medium in a mercaptan oxidation process. Hydrocarbon streams in refineries and chemical plants often contain unwanted contaminants such as organically bound sulfur compounds, carboxylic acids, and hydrogen sulfide. Product specifications may call for the reduction and/or removal of these contaminants during the refining process. Organically bound sulfur, such as mercaptan sulfur, may be present in some hydrocarbon streams within a refinery or chemical plant. It may be desirable to reduce the mercaptan sulfur content of a hydrocarbon stream to produce a product stream with reduced mercaptan sulfur content. There are generally two options for treating mercaptan sulfur containing streams. Mercaptan extraction may be utilized whereby the mercaptan sulfur is reacted with a caustic stream to produce an organo-sulfur compound such as a mercaptide. A portion of the mercaptide may dissolve in the aqueous portion of the caustic stream thereby removing the mercaptan sulfur from the hydrocarbon stream. In general, the solubility of the organo-sulfur compound is a function of the hydrocarbon chain length whereby relatively lower molecular weight mercaptans may produce a more soluble product when reacted with the caustic stream and relatively higher molecular weight mercaptans may produce a relatively less soluble product when reacted with the caustic stream. The organo-sulfur compound may be further oxidized to disulfide oil by reacting the organo-sulfur compound with oxygen in the presence of a catalyst. For some hydrocarbon streams containing heavier mercaptan sulfur containing compounds, mercaptan sweetening may be utilized to directly convert the mercaptan sulfur to the disulfide oil by reacting the mercaptan sulfur with oxygen in the presence of a catalyst. Sweetening directly to disulfide oil may be preferable in some hydrocarbon streams where the organo-sulfur compounds produced would be relatively insoluble in the aqueous portion of the caustic stream. Some operations may involve extraction and sweetening in series whereby a mixed hydrocarbon stream containing a portion of relatively lower molecular weight mercaptan sulfur and a relatively higher molecular weight mercaptan sulfur are contacted with a caustic stream followed by oxidation to produce disulfide oil. Such operations may occur in separate units or as an integrated process within a single vessel. An example of single vessel extraction/oxidation is the Mericat™ II process available from Merichem Company.

There may be a wide variety of hydrocarbon streams which contain contaminants that may be removed. While the present application may only disclose embodiments with regards to some specific hydrocarbon streams, the disclosure herein may be readily applied to other hydrocarbon streams not specifically enumerated herein. The caustic treatment process may be appropriate for treatment of any hydrocarbon feed including, but not limited to, hydrocarbons such as alkanes, alkenes, alkynes, and aromatics, for example. The hydrocarbons may comprise hydrocarbons of any chain length, for example, from about C₃ to about C₃₀, or greater, and may comprise any amount of branching. Some exemplary hydrocarbon feeds may include, but are not limited to, crude oil, propane, LPG, butane, light naphtha, isomerate, heavy naphtha, reformate, jet fuel, kerosene, diesel oil, hydro treated distillate, heavy vacuum gas oil, light vacuum gas oil, gas oil, coker gas oil, alkylates, fuel oils, light cycle oils, and combinations thereof. Some non-limiting examples of hydrocarbon streams may include crude oil distillation unit streams such as light naphtha, heavy naphtha, jet fuel, and kerosene, fluidized catalytic cracker or resid catalytic cracker gasoline (RCC), natural gasoline from natural gas liquids (NGL) fractionation, and gas condensates.

Methods of extracting mercaptan sulfur may include contacting the hydrocarbon stream with a caustic stream containing hydroxide and reacting at least a portion of the mercaptan sulfur content of the hydrocarbon stream with the hydroxide in the caustic stream. The hydroxide may be any hydroxide capable of reacting with mercaptan sulfur. Some exemplary hydroxides may include Group I and Group II hydroxides such as NaOH, KOH, RbOH, CsOH, Ca(OH)₂, and Mg(OH)₂, for example. The hydroxide may be present in an aqueous solution in a concentration suitable for a particular application, generally from about 5 wt. % up to and including saturation.

The generalized reaction of hydroxide and mercaptan sulfur is shown in Reaction 3 where the mercaptan sulfur (RSH) reacts with hydroxide (XOH), where X is a Group I or Group II cation, to form the corresponding mercaptide (RSX) and water.

RSH+XOH→RSX+H₂O Reaction 3

As discussed above, depending on the molecular weight of the mercaptan sulfur being reacted with the hydroxide, a portion of the mercaptide produced may dissolve in the aqueous portion of the caustic stream. Once the mercaptan sulfur is reacted with the caustic stream, a “spent caustic” or “rich caustic” solution containing the water, residual hydroxide, and soluble components may be generated. The spent caustic may be regenerated to form lean caustic with reduced mercaptide content for recycling back to Reaction 3. One process of regeneration may include mixing oxygen or air with the spent caustic and contacting the resultant mixture with a catalyst to regenerate the caustic stream. The generalized process of regeneration is shown in Reaction 4 where the mercaptide (RSX) reacts with water and oxygen in the presence of a catalyst produce disulfide (RSSR), also referred to as disulfide oil (DSO), caustic, and water.

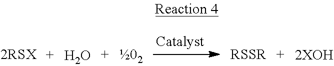

As discussed above, one of the challenges with treatment of mercaptan sulfur is that there may be issues with extent of reaction whereby the mercaptan sulfur concentration is not reduced to the level required for the resultant product stream to be on spec. In units which utilize an extractor section and an oxidation section, the catalyst may be dispersed in the caustic stream which circulates through the extraction and oxidation sections of the unit. In sweetening units, the catalyst may be contained in a fixed bed within a reactor. The catalyst may be impregnated in charcoal or activated carbon where the catalyst bed may be wetted with caustic solution. In either case, the catalyst may not have enough catalytic activity and/or residence time within the reactor may be too short to effectively oxide the mercaptides. One of the exemplary uses of the functional polymers disclosed herein is in replacing the conventional oxygenation catalysts presently utilized in the oxidation of mercaptides to produce disulfide oil. As will be discussed in detail below, functional polymers exhibit high reactivity to oxidation of mercaptides and have desirable physical properties which are well suited for use in mercaptide oxidation reactors.

There may be a wide variety of process conditions suitable for oxidation of the mercaptides, the exact conditions of which may vary depending on the hydrocarbon feed. For lighter hydrocarbons, operating pressure may be controlled to be slightly above the bubble point to ensure liquid-phase operation. For relatively heavier hydrocarbons, pressure may be set to keep air dissolved in the oxidation section. Operating temperature may also be selected based on the hydrocarbon feed with general conditions of temperature ranging from about 20° C. to about 100° C.

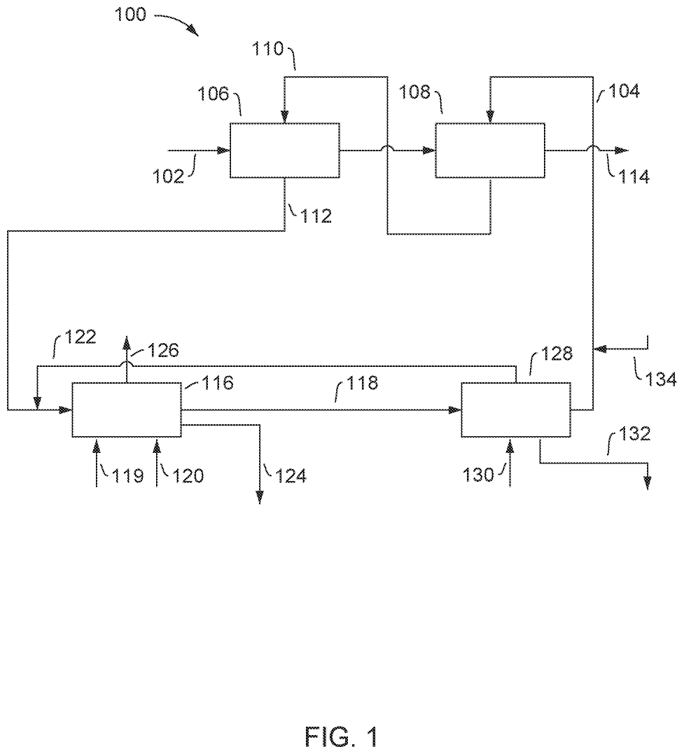

FIG. 1 illustrates one embodiment of a hydrocarbon desulfurization process 100 which may utilize functional polymers in mercaptide oxidation. In FIG. 1, hydrocarbon feed 102 containing mercaptan sulfur compounds may be treated in a counter current multiple stage caustic treatment section. Lean caustic 104 may be fed to a last stage 108 where the lean caustic extracts the mercaptans from the hydrocarbons entering last stage 108 after first being treated in first stage 106. The caustic may be removed from last stage 108 as stream 110 and may be fed to first stage 106 and be contacted with hydrocarbon feed 102. Spent caustic stream 112 may be withdrawn from first stage 106 and the treated hydrocarbon 114 may be withdrawn from last stage 108. The specific design of the caustic treatment section is not critical the functionality of the functional polymers of the present disclosure, however, one design may include staged contactors operating in a counter-current configuration as schematically illustrated in FIG. 1, and another design may be using fiber film liquid-liquid contactor to assist in the mass transfer of the mercaptans from the hydrocarbon feed 102 into the caustic treatment solution.

Spent caustic stream 112 withdrawn from first stage 106 and oxidizer 119 may be fed to oxidation section 116. Oxidizer 119 may include any suitable oxidizer, including air, oxygen, hydrogen peroxide, or any other oxygen containing gas or compound which releases oxygen. Oxidation section 116 may include functional polymers disclosed herein capable of oxidizing mercaptides present in spent caustic stream 112 to form disulfide oil. The mercaptides, water, and oxygen in spent caustic stream 112 may react according to Reaction 4 in the presence of the functional polymers to produce disulfide oil, regenerated caustic, and water. The regenerated caustic may be drawn off as regenerated caustic stream 118 and the disulfide oil may be drawn off as disulfide stream 124. Off-gas stream 126 containing residual gaseous hydrocarbons, air, oxygen, or other gasses may be withdrawn from oxidation section 116 and sent to a downstream unit for further processing or to flare as needed.

As the conditions within oxidation section 116 may be conducive to forming an explosive mixture with combinations of hydrocarbon and oxidizer, it may be desired to operate the oxidation section 116 such that the gasses present in oxidation section 116 are below the lower explosive limit (LEL) or above the upper explosive limit (UEL). A gas stream 120 may optionally be introduced into oxidation section 116 such that the LEL/UEL conditions are maintained. Gas stream 120 may include fuel gas, inert gas, or any other suitable gas to control LEL/UEL. Another alternative may be the inclusion of solvent stream 122 into oxidation section 116. Solvent stream 122 may be from any source but should preferably contain little to no disulfide oil. Solvent stream 122 may be mixed with spent caustic stream 112 prior to entering the oxidation section 116 or it may be injected as a separate stream into the bottom of oxidation section 116. The solvent may be any light hydrocarbon or mixture of light hydrocarbons such as naphtha and kerosene that will assist in the separation of the disulfide oil from the caustic solution after oxidation of the mercaptans. The disulfide oil may have a higher solubility in the solvent as compared to the aqueous portion of spent caustic stream 112, with their differential of solubility providing an extractive driving force for the DSO. In examples where a solvent is utilized, the solvent may be drawn off with the disulfide oil in disulfide stream 124.

In some examples, regenerated caustic stream 118 may be further purified in solvent wash section 128 whereby a solvent stream 130 may contact regenerated caustic stream 118 to further remove DSO from the regenerated caustic stream 118. A Spent caustic stream 132 may be withdrawn from solvent wash section 128 and additional fresh caustic from fresh caustic stream 134 may be added to form lean caustic 104.

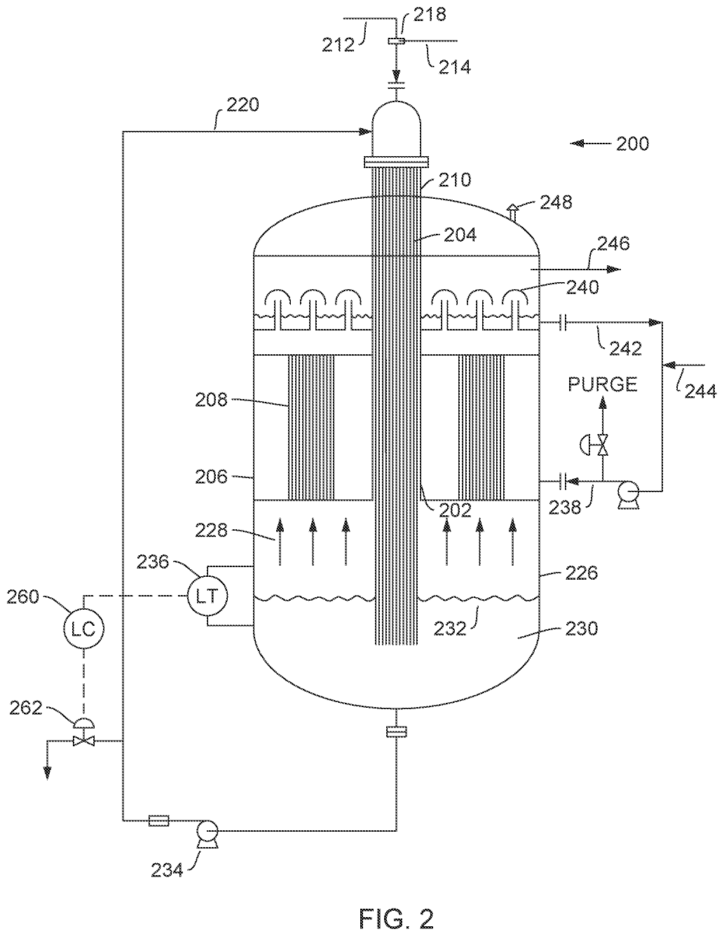

FIG. 2 illustrates one embodiment of a hydrocarbon desulfurization vessel 200 containing functional polymers described herein. As illustrated, hydrocarbon desulfurization vessel 200 contains a caustic treatment section 202 containing fiber bundle 204 and an oxidation section 206 containing functional polymers 208. Conduit 210 may contain caustic treatment section 202 containing fiber bundle 204 which may physically separate caustic treatment section 202 from oxidation section 206 and provide a flow path for fluid to flow through. Oxidation section 206 containing functional polymers 208 may be disposed in an annular space formed between conduit 210 and the walls of vessel 200.

The hydrocarbon feed 212 containing mercaptan sulfur compounds to be treated may be mixed with oxidizer 214 and introduced into conduit 210. In some examples, sparger 218 may be utilized to distribute oxidizer 214 into hydrocarbon feed 212. Oxidizer 214 may include any suitable oxidizer, including air, oxygen, hydrogen peroxide, or any other oxygen containing gas or compound which releases oxygen. Generally, the amount of oxidizer 214 introduced should be sufficient to oxidize all mercaptan sulfur compounds present in hydrocarbon feed 212. Once the hydrocarbon/oxidizer feed is introduced into conduit 210, it may flow through conduit 210 and contact fiber bundle 204. Caustic stream 220 may be introduced into conduit 210 such that the hydrocarbon/oxidizer feed may be mixed with caustic stream 220 before contacting fiber bundle 204. In some examples, it may be desired to disperse the caustic from caustic stream 220 to enhance contact between the hydrocarbon phase from hydrocarbon feed 212 and the aqueous phase from caustic stream 220.

Hydrocarbon/oxidizer feed and caustic from caustic stream 220 may contact fiber bundle 204 which may cause the aqueous caustic to wet the individual fibers of fiber bundle 204. The aqueous caustic solution will form a film on fibers 204 which will be dragged downstream through conduit 210 by passage of hydrocarbon through same conduit. Both liquids may be discharged into separation section 226 of the vessel 200. The volume of the hydrocarbon will be greater because the aqueous caustic passes through the fiber bundle at a lower volumetric flow rate than the hydrocarbon. During the relative movement of the hydrocarbon with respect to the aqueous caustic film on the fibers, a new interfacial boundary between the hydrocarbon and the aqueous caustic solution is continuously being formed, and as a result fresh aqueous caustic solution is brought in contact with this surface and allowed to react with the mercaptan sulfur or other impurities such as phenolics, naphthenic acid and other organic acids in the hydrocarbon. Mercaptan sulfur present in the hydrocarbon feed may be reacted with the caustic to produce mercaptides as shown in Reaction 3.

In separation section 226, the aqueous caustic solution and hydrocarbon may collect in the lower portion of the vessel 200 and separate into hydrocarbon phase 228 and caustic phase 230. The interface 232 within vessel 200 may be kept at a level above the bottom of the downstream end of fiber bundle 204 so that the aqueous caustic film can be collected directly in the bottom of vessel 200 without it being dispersed into the hydrocarbon phase 228. Most of the phenolate or naphthenate impurities which may cause plugging in a packed bed are thus removed from the hydrocarbon in the caustic phase. Not only does this increase oxidation efficiency but reduces maintenance costs as well. However, some impurities may remain in the hydrocarbon which may be necessary to further treat the with caustic solution in oxidation section 206. Caustic phase 230 may be withdrawn from vessel 200 via pump 234 and may be returned to conduit 210 via caustic stream 220. The height of interface 232 within vessel 200 may be controlled by level controls system which may include a level sensor 236, a level controller 260, and a purge valve 262, which may be configured to keep interface 232 at a level above the downstream end of fiber bundle 204.

If additional reaction is required to convert mercaptans, hydrocarbon phase 228 may be directed to an optional oxidation section 206. From separation section 226, hydrocarbon phase 228 may flow upwards into oxidation section 206, whereby the hydrocarbon phase 228 may contact functional polymers 208. Additional caustic, if necessary, may be introduced into oxidation section 206 via line 238. A distribution grid may be present in oxidation section 206 which may distribute caustic from line 238 into oxidation section 206. In oxidation section 206 mercaptides, water, and oxygen may react according to Reaction 4 in the presence of the functional polymers to produce disulfide oil, regenerated caustic, and water which may flow upwards through oxidation section 206. The additional caustic and hydrocarbon may be in contact and in concurrent flow through oxidation section 206. At the upper end of the functional polymers, the additional caustic may be separated from the hydrocarbon by a liquid separator device such as chimney type trays in separation section 240. While chimney type trays are illustrated, there may be many alternative types of liquid separators can be used such as overflow weirs, for example. The additional hydroxide may be collected in separation section 240 and be drawn off as stream 242 to be re-introduced into oxidation section 206. Makeup caustic 244 may be added intermittently and a caustic purge may be utilized as needed. Hydrocarbon product 246 may be withdrawn from the top of separation section 240. Off-gas buildup in vessel 200 may be drawn off through line 248 and be processed in downstream units.

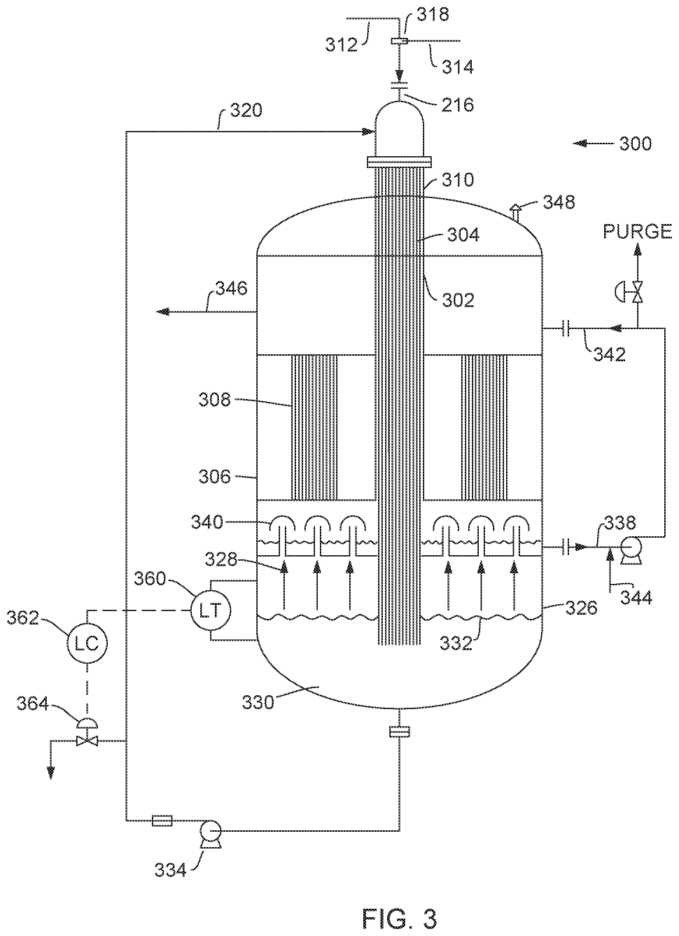

FIG. 3 illustrates another embodiment of a hydrocarbon desulfurization vessel 300 containing functional polymers described herein. As illustrated, hydrocarbon desulfurization vessel 300 contains a caustic treatment section 302 containing fiber bundle 304 and an oxidation section 306 containing functional polymers 308. Conduit 310 may contain caustic treatment section 302 containing fiber bundle 304 which may physically separate caustic treatment section 302 from oxidation section 306 and provide a flow path for fluid to flow through. Oxidation section 306 containing functional polymers 308 may be disposed in an annular space formed between conduit 310 and the walls of vessel 300.

The hydrocarbon feed 312 containing mercaptan sulfur compounds to be treated may be mixed with oxidizer 314 and introduced into conduit 310. In some examples, sparger 318 may be utilized to distribute oxidizer 314 into hydrocarbon feed 321. Oxidizer 314 may include any suitable oxidizer, including air, oxygen, hydrogen peroxide, or any other oxygen containing gas or compound which releases oxygen. Generally, the amount of oxidizer 314 introduced should be sufficient to oxidize all mercaptan sulfur compounds present in hydrocarbon feed 312. Once the hydrocarbon/oxidizer feed is introduced into conduit 310, it may flow through conduit 310 and contact fiber bundle 304. Caustic stream 320 may be introduced into conduit 310 such that the hydrocarbon/oxidizer feed may be mixed with caustic stream 320 before contacting fiber bundle 304. In some examples, it may be desired to disperse the caustic from caustic stream 320 to enhance contact between the hydrocarbon phase from hydrocarbon feed 312 and the aqueous phase from caustic stream 320.

Hydrocarbon/oxidizer feed and caustic from caustic stream 320 may contact fiber bundle 304 which may cause the aqueous caustic to wet the individual fibers of fiber bundle 304. The aqueous caustic solution will form a film on fiber bundle 304 which will be dragged downstream through conduit 310 by passage of hydrocarbon through same conduit. Both liquids may be discharged into separation section 326 of the vessel 300. The volume of the hydrocarbon will be greater because the aqueous caustic passes through the fiber bundle at a lower volumetric flow rate than the hydrocarbon. During the relative movement of the hydrocarbon with respect to the aqueous caustic film on the fibers, a new interfacial boundary between the hydrocarbon and the aqueous caustic solution is continuously being formed, and as a result fresh aqueous caustic solution is brought in contact with this surface and allowed to react with the mercaptan sulfur or other impurities such as phenolics, naphthenic acid and other organic acids in the hydrocarbon. Mercaptan sulfur present in the hydrocarbon feed may be reacted with the caustic to produce mercaptides as shown in Reaction 3.

In separation section 326, the aqueous caustic solution and hydrocarbon may collect in the lower portion of the vessel 300 and separate into hydrocarbon phase 328 and caustic phase 330. The interface 332 within vessel 300 may be kept at a level above the bottom of the downstream end of fiber bundle 304 so that the aqueous caustic film can be collected directly in the bottom of vessel 300 without it being dispersed into the hydrocarbon phase 328. Most of the phenolate or naphthenate impurities which may cause plugging in a packed bed are thus removed from the hydrocarbon in the caustic phase. Not only does this increase oxidation efficiency but reduces maintenance costs as well. However, some impurities may remain in the hydrocarbon which may be necessary to further treat the with caustic solution in oxidation section 306. Caustic phase 330 may be withdrawn from vessel 300 via pump 334 and may be returned to conduit 310 via caustic stream 320. The height of interface 332 within vessel 300 may be controlled by level controls system which may include a level sensor 360, a level controller 362, and a purge valve 364, which may be configured to keep interface 332 at a level above the downstream end of fiber bundle 304.

From separation section 326, hydrocarbon phase 328 may flow upwards into separation section 340 and further into oxidation section 306 whereby the hydrocarbon phase 328 may contact functional polymers 308. At the upper end of functional polymers 308 caustic from stream 342 may be pumped into oxidation section 306 and may contact functional polymers 308. A distribution grid may be present in oxidation section 306 which may distribute caustic from stream 342 into oxidation section 206. Caustic from stream 342 may flow down functional polymers 308 as hydrocarbon phase 328 flow up functional polymers 308 in counter-current flow in oxidation section 306. In oxidation section 306 mercaptides, water, and oxygen may react according to Reaction 4 in the presence of the functional polymers to produce disulfide oil, regenerated caustic, and water which may flow down through oxidation section 306 to separation section 340. At the lower end of the functional polymers, caustic and hydrocarbon may be separated by a liquid separator device such as chimney type trays in separation section 340. While chimney type trays are illustrated, there may be many alternative types of liquid separators can be used such as overflow weirs, for example. Separated caustic from separation section 340 may be drawn off at stream 338 to be reintroduced into oxidation section 306 though stream 342. Makeup caustic 344 may be added intermittently and a caustic purge may be utilized as needed. Hydrocarbon product 346 may be withdrawn from above or the top of oxidation section 306. Off-gas buildup in vessel 300 may be drawn off through line 348 and be processed in downstream units.

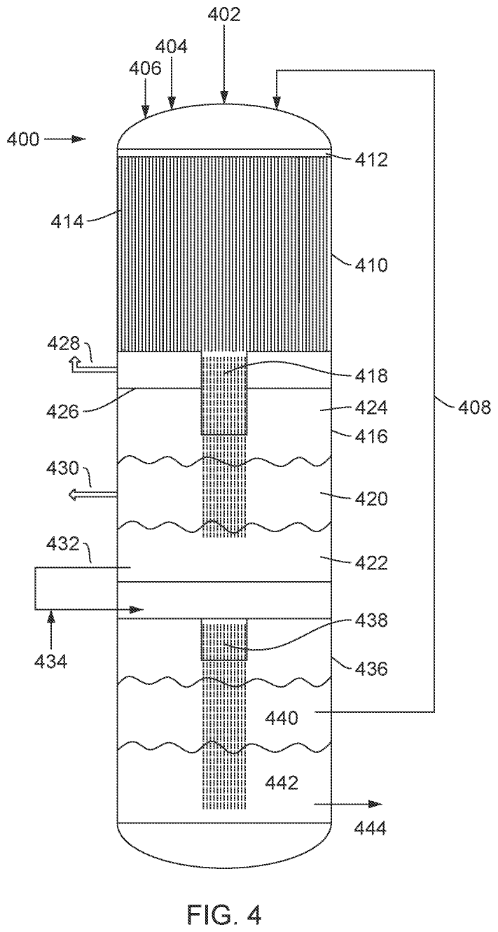

FIG. 4 illustrates another embodiment of a caustic regeneration vessel 400 containing functional polymers described herein. FIG. 4 illustrates a process conducted in a single vessel where a caustic feed 402 containing a caustic solution and mercaptides, oxidizer 404, optionally hydrocarbon gas stream 406, and, optionally, solvent stream 408 may be introduced into oxidation section 410. Hydrocarbon gas stream 406 may include any hydrocarbons including gasses such as a fuel gas, for example. Hydrocarbon gas stream 406 may be added in proportion to oxidizer 404 so as to ensure the environment within vessel 400 is above the upper explosive limit (UEL) Oxidizer 404 may include any suitable oxidizer, including air, oxygen, hydrogen peroxide, or any other oxygen containing gas or compound which releases oxygen. Each of the streams may be introduced into vessel 400 through distributor 412 which may distribute the feeds into oxidation section 410. Oxidation section 410 contains functional polymers 414 arranged to receive the feeds from distributor 412.

In oxidation section 410, the caustic from caustic feed 402 and solvent from solvent stream 408 may contact functional polymers 414 which may cause the aqueous caustic to wet the individual fibers of functional polymers 414. The aqueous caustic solution will form a film on functional polymers 414 which will be dragged downstream through oxidation section 410 by passage of oxidizer 404 through vessel 400. During the relative movement of oxidizer 404 with respect to the aqueous caustic film on the fibers, a new interfacial boundary between the oxidizer and the aqueous caustic solution is continuously being formed, and as a result fresh aqueous caustic solution is brought in contact with this surface and allowed to react with the mercaptide sulfur or other impurities such as phenolics, naphthenic acid and other organic acids in the caustic feed 402. The mercaptides react with oxygen provided by oxidizer 404 as shown in Reaction 4 in the presence of functional polymers 414 to produce disulfide oil, regenerated caustic, and water.

The oxidation of mercaptides into disulfide oil occurring within the oxidation section 410 may results in a mixture composed of continuous phase caustic, discontinuous phase organic (disulfide oil, and solvent if present) droplets dispersed in the caustic phase, and gas (nitrogen and unreacted oxygen from air). The mixture of products, unreacted reactants, and inert species may exit oxidation section 410 and contact fiber bundle 418 and flow into separation section 416. The fiber bundle may promote phase separation as explained previously. In separation section 416, the aqueous caustic and hydrocarbon may collect in the lower portion of separation section 416 and separate into hydrocarbon phase 420 containing solvent if present and disulfide oil, caustic phase 422, and gas phase 424. Gas from oxidizer 404 disengages from liquid stream at the outlet of fiber bundle 418 and exits through a mist eliminator 426 as off-gas 428. The two immiscible liquids, as a single stream of aqueous and hydrocarbon, flow downwards along fiber bundle 418 during which organic hydrocarbon droplets coalesce and form hydrocarbon phase 420 containing the majority of generated disulfide oil, while the aqueous caustic adheres to the fibers and flows further downward to form caustic phase 422.

Hydrocarbon phase 420 containing the hydrocarbons from solvent stream 408, if present, as well as the generated disulfide oil may be withdrawn as stream 430. Caustic phase 422 may contain a residual amount of disulfide oil which may be further removed before the caustic is reused. Caustic phase 422 may be withdrawn as stream 432 which may be mixed with fresh solvent stream 434 before contacting fiber bundle 438 and flowing into separation section 436. In separation section 436, the aqueous caustic from caustic phase 422 and solvent from fresh solvent stream 434 may collect in the lower portion of separation section 436 and separate into solvent phase 440 and caustic phase 442. Solvent phase 440 may contain the bulk of any residual disulfide oil present in caustic phase 422 after flowing through fiber bundle 438. Solvent phase 440 may be withdrawn and recycled to vessel 400 as solvent stream 408. Regenerated caustic phase 442 may be withdrawn and recycled as stream 444 and reused.

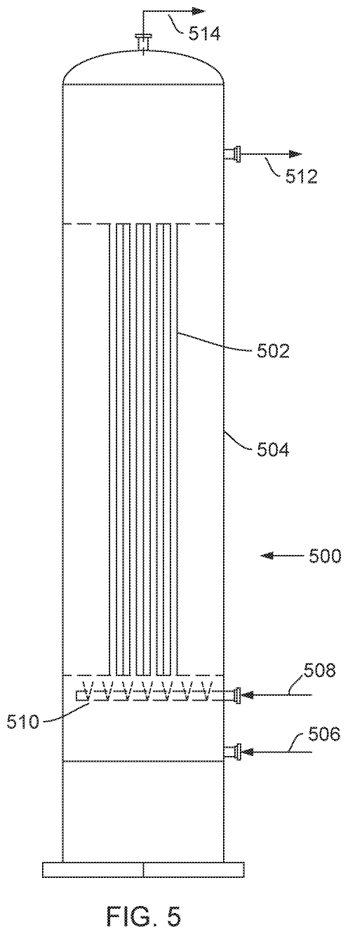

FIG. 5 illustrates a standalone caustic regeneration vessel 500 comprising functional polymers 502 disposed in oxidation zone 504. Rich caustic stream 506, containing mercaptides and/or sulfides, enters the bottom of caustic regeneration vessel 500. Oxidizer 508 is introduced into caustic regeneration vessel 500 through optional distributor 510 and mixes with the rich caustic from rich caustic stream 506. Rich caustic stream 506 may be from any unit, including those previously described herein, which contains a rich caustic and mercaptides. Oxidizer 508 may include any suitable oxidizer, including air, oxygen, hydrogen peroxide, or any other oxygen containing gas or compound which releases oxygen. The mixture of oxidizer 508 and rich caustic stream 506 may contact functional polymers 502 which may cause the aqueous caustic to wet the individual fibers of functional polymers 502. Caustic and oxidizer flow co-currently up through functional polymers 502 such that mercaptides present in rich caustic stream 506 react with oxygen provided by oxidizer 508 as shown in Reaction 4 in the presence of functional polymers 502 to produce disulfide oil, regenerated caustic, and water. The resultant disulfide oil, regenerated caustic, or both may be withdrawn from caustic regeneration vessel 500 as stream 512. Although illustrated in FIG. 5 as one stream, stream 512 may be two or more streams such as in previous figures where an aqueous phase and oleaginous phase are separately withdrawn. Off-gas 514 may also be withdrawn from caustic regeneration vessel 500.

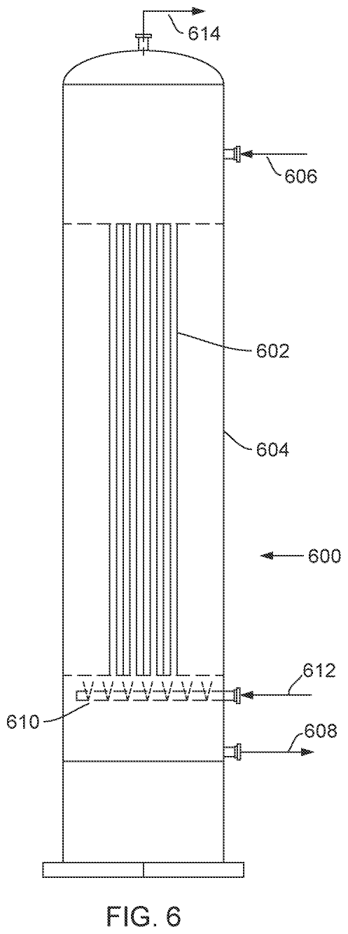

FIG. 6 illustrates an alternate counter-current configuration for a standalone caustic regeneration vessel 600 comprising functional polymers 602 disposed in oxidation zone 604. Rich caustic stream 606, containing mercaptides and/or sulfides, enters the top of vessel 600 which enter oxidation zone 604 and wets functional polymers 602. Rich caustic stream 606 may be from any unit, including those previously described herein, which contains a rich caustic and mercaptides. Oxidizer 612 is introduced into caustic regeneration vessel 600 through optional distributor 610.

and flows up functional polymers 602. Oxidizer 612 may include any suitable oxidizer, including air, oxygen, hydrogen peroxide, or any other oxygen containing gas or compound which releases oxygen. Caustic and oxidizer flow counter-currently through functional polymers such that mercaptides present in rich caustic stream 606 further react with oxygen provided by oxidizer 612 as shown in Reaction 4 in the presence of functional polymers 602 to produce disulfide oil, regenerated caustic, and water. The resultant disulfide oil, regenerated caustic, or both may be withdrawn from caustic regeneration vessel 600 as stream 608. Although illustrated in FIG. 6 as one stream, stream 608 may be two or more streams such as in previous figures where an aqueous phase and oleaginous phase are separately withdrawn. Off-gas 614 may also be withdrawn from caustic regeneration vessel 600.

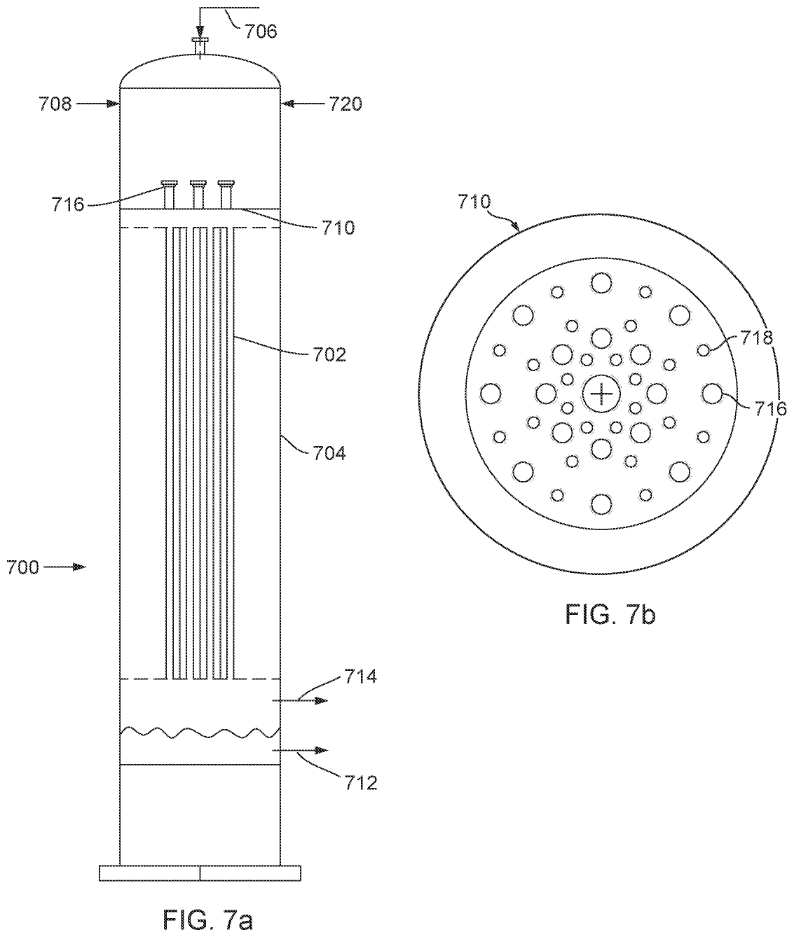

FIG. 7a illustrates a standalone caustic regeneration unit 700 comprising functional polymer 702 disposed in an oxidation zone 704. Rich caustic stream 706, containing mercaptides and/or sulfides enters the top of the vessel. Oxidizer 708 enters above the distributor tray 710. Oxidizer 708 may include any suitable oxidizer, including air, oxygen, hydrogen peroxide, or any other oxygen containing gas or compound which releases oxygen. An example of the distributor tray is shown in FIG. 7b but other variations may apply equally well. On the distributor tray 710, a solvent stream 720 may also be introduced above the distributor tray 710. Distributor tray 710 distributes these phases onto the functional polymer 702. In some embodiments, riser pipes 716 may be disposed on distributor tray 710. The mixture of at least oxidizer 708 and rich caustic stream 706 may contact the functional polymer 702 which may cause the aqueous caustic to wet the individual fibers of functional polymers 702. Mercaptides present in caustic stream 706 further react with oxygen provided by oxidizer 708 as shown in Reaction 4 in the presence of functional polymers 702 to produce disulfide oil, regenerated caustic, and water which may flow downwards along functional polymers 702. The resultant disulfide oil, regenerated caustic, or both may be withdrawn from regeneration unit 700 as stream 712. Although illustrated in FIG. 7a as one stream, stream 712 may be two or more streams such as in previous figures where an aqueous phase and oleaginous phase are separately withdrawn. Off-gas 714 may also be withdrawn from caustic regeneration unit 700. FIG. 7b shows a top view of distributor tray 710 with riser pipes 716 and holes 718 to allow for the fluids to flow through the distributor tray 710.

Accordingly, the present disclosure may provide methods, systems, and apparatus that may relate to methods to prepare functional polymers and methods of using functional polymers. The methods, systems. and apparatus may include any of the various features disclosed herein, including one or more of the following statements.

Statement 1. A method of producing a functional polymer comprising: providing a polymer comprising carboxyl groups on a surface of the polymer and a macrocycle comprising an amine on a surface of the macrocycle; mixing the polymer and the macrocycle; and reacting the polymer and the macrocycle to form an amide bond between the polymer and the macrocycle thereby forming the functional polymer.

Statement 2. The method of statement 1 wherein the polymer comprises one or more polymers selected from the group consisting of polysaccharides, polyisoprenes, polyamides, aromatic polyamides, polyesters, polyolefins, polychloroprenes, polybutadienes, butyl rubber, styrene butadiene rubber, nitrile rubber, and combinations thereof.

Statement 3. The method of any of statements 1-2 wherein the polymer comprises one or more polymers selected form the group consisting of cellulose, natural rubber, wool, polyester, polyethylene, polypropylene, polystyrene, neoprene, nylon, and combinations thereof.

Statement 4. The method of any of statements 1-3 wherein the macrocycle comprises one or more macrocycles selected from the group consisting of porphyrin and derivatives thereof, phthalocyanine macrocycles and derivatives thereof, crown ethers and derivatives thereof, aza substituted crown ethers and derivatives thereof, polyaza macrocycles and derivatives thereof, polythia macrocycles and derivatives thereof, polyphospha macrocycles and derivatives thereof, polypyridone macrocycles and derivatives thereof, and combinations thereof.

Statement 5. The method of any of statements 1-4 wherein the macrocycle comprises one or more macrocycles selected from the group consisting of mono and/or poly amino metal phthalocyanines, mono and/or poly carboxyl metal phthalocyanines, macrocyclic pyridone pentamer, cyclam, aminobenzo-18-crown-6, 2-aminomethyl-18-crown-6, combinations thereof.

Statement 6. The method of any of statements 1-5 wherein the macrocycle comprises one or more structures selected from the group consisting of:

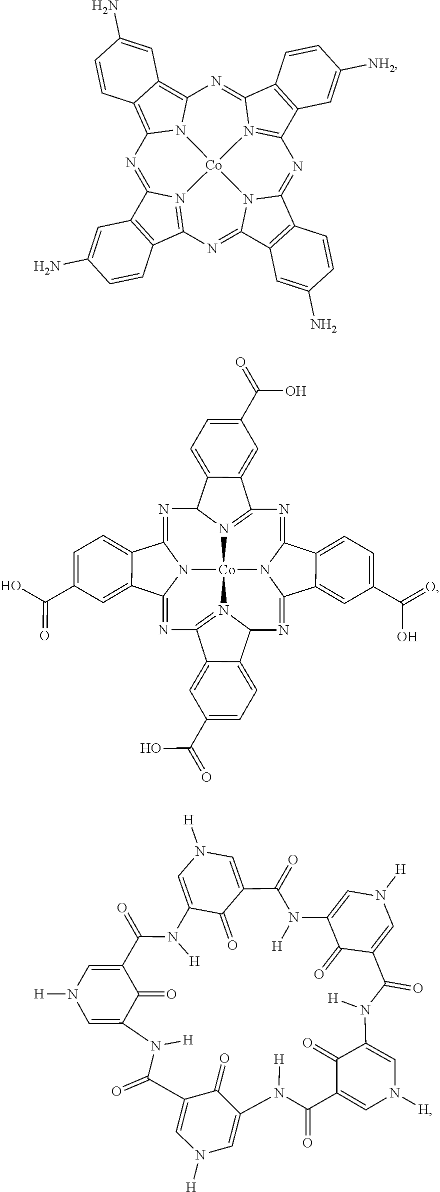

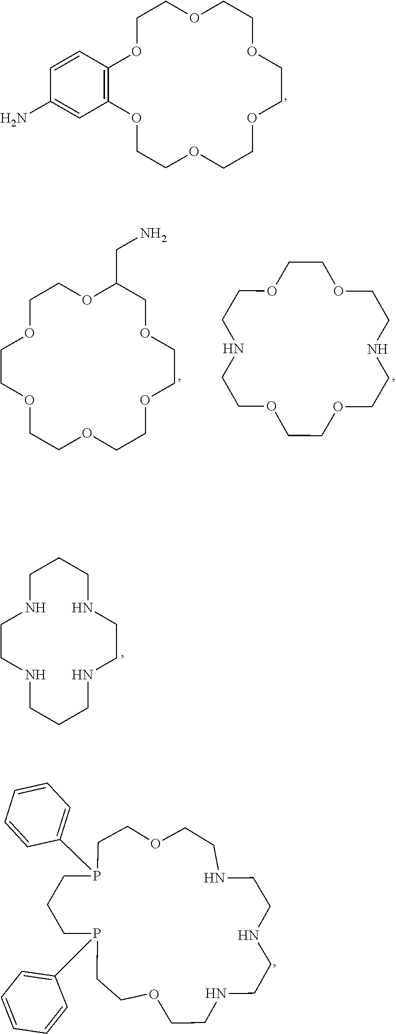 [SMILES: Nc1ccc2c(c1)OCCOCCOCCOCCOCCO2 ; NCC1COCCOCCOCCOCCOCCO1 ; C1COCCOCCNCCOCCOCCN1 ; C1CNCCNCCCNCCNC1 ; c1ccc(P2CCCP(c3ccccc3)CCOCCNCCNCCNCCOCC2)cc1]

and combinations thereof.

Statement 7. The method of any of statements 1-6 further comprising mixing the polymer and the macrocycle in a solvent and heating the solvent to a temperature sufficient to react the polymer and the macrocycle.

Statement 8. The method of any of statement 7 wherein the solvent comprises at least one solvent selected from the group consisting of water, pyridine, DMSO, DMF, THF, ethanol, acetonitrile, chloroform, ethylene glycol, methanol, benzene, and combinations thereof.

Statement 9. The method of any of statements 1-8 further comprising: reacting the polymer with a chlorinating agent to produce a polymer comprising acyl chloride; and reacting the polymer comprising acyl chloride and the macrocycle.

Statement 10. The method of statement 9 wherein the chlorinating agent comprises at least one chlorinating agent selected from the group consisting of thionyl chloride, phosphorous trichloride, terephthaloyl chloride, and combinations thereof.

Statement 11. The method of any of statements 1-10 further comprising: reacting the polymer with a coupling agent to produce a coupling agent modified polymer; and reacting the coupling agent modified polymer with the macrocycle.

Statement 12. The method of statement 11 wherein the coupling agent comprises at least one coupling agent selected from the group consisting of carbodiimide, benzotriazole, and combinations thereof.

Statement 13. The method of any of statements 1-12 further comprising: providing an enzyme capable of catalyzing the amide bond formation; and reacting the polymer with the macrocycle in the presence of the enzyme to form the amide bond.

Statement 14. The method of statement 13 wherein the enzyme comprises one or more enzymes selected from the group consisting of proteases, subtilisin, acylases, amidases lipases, and combinations thereof.

Statement 15. The method of any of statements 1-14 further comprising oxidizing a virgin polymer to produce the polymer comprising carboxyl groups.

Statement 16. The method of statement 15 wherein oxidizing comprises at least one oxidation process selected from gamma-radiation treatment, plasma treatment, UV treatment, or chemical oxidation.

Statement 17. The method of statement 16 wherein chemical oxidation comprises oxidizing with at least one oxidizer selected from hydrochloric acid, nitric acid, phosphoric acid, sulfuric acid, boric acid, hydrofluoric acid, hydrobromic acid, perchloric acid, hydroiodic acid, fluoroantimonic acid, carborane acids, fluoroboric acid, fluorosulfuric acid, hydrogen fluoride, triflic acid, perchloric acid, acetic acid, formic acid, citric acid, oxalic acid, and tartaric acid, ozone, hydrogen peroxide, sodium hypochlorite, permanganate, potassium chromate, potassium dichromate, chlorine dioxide, transition metal nitrates, and combinations thereof.

Statement 18. A method of producing a functional polymer comprising: providing a polymer comprising an amine group on a surface of the polymer and a macrocycle comprising a carboxyl group on a surface of the macrocycle; mixing the polymer and the macrocycle; and reacting the polymer and the macrocycle to form an amide bond between the polymer and the macrocycle thereby forming the functional polymer.

Statement 19. A method comprising: introducing into a fiber bundle contactor a hydrocarbon comprising mercaptan sulfur, an aqueous caustic solution, and an oxidizer, wherein the fiber bundle contactor comprises a flow path defined by a conduit, a functional polymer disposed in the conduit, and an inlet allowing fluid flow into the flow path, wherein the functional polymer comprises a polymer and a macrocycle grafted to the polymer; reacting at least a portion of the mercaptan sulfur and the aqueous caustic solution to produce a mercaptide; and reacting the mercaptide and the oxidizer in the presence of the functional polymer to produce a disulfide oil.

Statement 20. The method of statement 19 wherein the polymer comprises one or more polymers selected from the group consisting of polysaccharides, polyisoprenes, polyamides, aromatic polyamides, polyesters, polyolefins, polychloroprenes, polybutadienes, butyl rubber, styrene butadiene rubber, nitrile rubber, and combinations thereof.

Statement 21. The method of any of statements 18-20 wherein the macrocycle comprises one or more macrocycles selected from the group consisting of porphyrin and derivatives thereof, phthalocyanine macrocycles and derivatives thereof, crown ethers and derivatives thereof, aza substituted crown ethers and derivatives thereof, polyaza macrocycles and derivatives thereof, polythia macrocycles and derivatives thereof, polyphospha macrocycles and derivatives thereof, polypyridone macrocycles and derivatives thereof, and combinations thereof.

Statement 22. A method comprising: providing a functional polymer comprising a polymer and a macrocycle grafted to the polymer; contacting the functional polymer with a solution comprising metal ions; and adsorbing at least a portion of the metal ions with the functional polymer.

Statement 23. The method of statement 22 wherein the polymer comprises one or more polymers selected from the group consisting of polysaccharides, polyisoprenes, polyamides, aromatic polyamides, polyesters, polyolefins, polychloroprenes, polybutadienes, butyl rubber, styrene butadiene rubber, nitrile rubber, and combinations thereof.

Statement 24. The method of any of statements 21-23 wherein the macrocycle comprises one or more macrocycles selected from the group consisting of porphyrin and derivatives thereof, phthalocyanine macrocycles and derivatives thereof, crown ethers and derivatives thereof, aza substituted crown ethers and derivatives thereof, polyaza macrocycles and derivatives thereof, polythia macrocycles and derivatives thereof, polyphospha macrocycles and derivatives thereof, polypyridone macrocycles and derivatives thereof, and combinations thereof.

Statement 25. A functional polymer comprising: a polymer; and a macrocycle, wherein the macrocycle is grafted to the polymer by an amide bond formed between the macrocycle and the polymer.

Statement 26. The functional polymer of statement 25 wherein the polymer comprises one or more polymers selected from the group consisting of polysaccharides, polyisoprenes, polyamides, aromatic polyamides, polyesters, polyolefins, polychloroprenes, polybutadienes, butyl rubber, styrene butadiene rubber, nitrile rubber, and combinations thereof.

Statement 27. The functional polymer of any of statements 24-26 wherein the macrocycle comprises one or more macrocycles selected from the group consisting of porphyrin and derivatives thereof, phthalocyanine macrocycles and derivatives thereof, crown ethers and derivatives thereof, aza substituted crown ethers and derivatives thereof, polyaza macrocycles and derivatives thereof, polythia macrocycles and derivatives thereof, polyphospha macrocycles and derivatives thereof, polypyridone macrocycles and derivatives thereof, and combinations thereof.

Statement 28. An apparatus comprising: a flow path defined by a conduit; and a functional polymer disposed in the conduit, wherein the functional polymer comprises a polymer and a macrocycle, wherein the macrocycle is grafted to the polymer by an amide bond formed between the macrocycle and the polymer.

Statement 29. The apparatus of statement 28 wherein the polymer comprises one or more polymers selected from the group consisting of polysaccharides, polyisoprenes, polyamides, aromatic polyamides, polyesters, polyolefins, polychloroprenes, polybutadienes, butyl rubber, styrene butadiene rubber, nitrile rubber, and combinations thereof.

Statement 30. The apparatus of any of statements 27-29 wherein the macrocycle comprises one or more macrocycles selected from the group consisting of porphyrin and derivatives thereof, phthalocyanine macrocycles and derivatives thereof, crown ethers and derivatives thereof, aza substituted crown ethers and derivatives thereof, polyaza macrocycles and derivatives thereof, polythia macrocycles and derivatives thereof, polyphospha macrocycles and derivatives thereof, polypyridone macrocycles and derivatives thereof, and combinations thereof.

### EXAMPLES

To facilitate a better understanding of the present disclosure, the following illustrative examples of some of the embodiments are given. In no way should such examples be read to limit, or to define, the scope of the disclosure.

### Example 1

In this Example, catalytic polypropylene fiber was prepared and evaluated. Chlorine dioxide was prepared by combining 5.74 grams of sodium chloride and 50 mL of 1N hydrochloric acid at room temperature. A 5.04 gram sample of polypropylene fiber was treated with the chlorine dioxide gas under 365 nm UV light at room temperature for 30 minutes to produce chlorine dioxide treated propylene fibers. Chlorine dioxide gas attacks methyl groups of the polypropylene, converting them to carboxylic acid. Next, 0.4 grams of mono-amino cobalt phthalocyanine (MACoPc) was dissolved in 175 mL dimethyl sulfoxide (DMSO). A 5.25 gram aliquot of the chlorine dioxide treated propylene fibers was added to the mono-amino cobalt phthalocyanine solution and heated at 115° C. for 6 hours to graft the mono-amino cobalt phthalocyanine to the chlorine dioxide treated propylene fibers to produce catalytic polypropylene fiber. The catalytic polypropylene fiber as washed with DMSO and DI water followed by drying in an oven at 60° C.

A mercaptan solution was prepared by dissolving mercaptan in hexane until a concentration of about 350 ppm (parts per million) mercaptan was reached. A 3 gram sample of catalytic polypropylene fiber was added to 150 mL of the mercaptan solution and mixed vigorously using a shaker bath at 300 RPM and 38° C. Kerosene samples were collected over the course of 30 minutes and the mercaptan concentrations were determined by titration. It was found that the first order mercaptan oxidation rate constant was 0.041 min⁻¹.

### Example 2

In this Example, a catalytic propylene fiber was prepared and evaluated. A 5.21 gram propylene fiber sample and 11.87 gram sample of potassium permanganate (KMnO₄) were measured and added to 289.50 grams of 0.5 N HCl solution. The solution was mixed at 48° C. for 7 hours to produce KMnO₄ treated polypropylene fiber. The KMnO₄ treated propylene fiber was washed with concentrated HCl and DI water, followed by drying in an oven at 60° C. Next, 0.4 grams of mono-amino cobalt phthalocyanine were dissolved in 175 m DMSO. A 5.01 gram aliquot of the KMnO₄ treated polypropylene fiber was added to the mono-amino cobalt phthalocyanine solution and heated at 117° C. for 6 hours to graft the mono-amino cobalt phthalocyanine to the KMnO₄ treated polypropylene fiber to produce catalytic polypropylene fiber. The catalytic polypropylene fiber as washed with DMSO and DI water followed by drying in an oven at 60° C.

A mercaptan solution was prepared by dissolving mercaptan in hexane until a concentration of about 350 ppm (parts per million) mercaptan was reached. A 3 gram sample of catalytic polypropylene fiber was added to 150 mL of the mercaptan solution and mixed vigorously using a shaker bath at 300 RPM and 38° C. Kerosene samples were collected over the course of 30 minutes and the mercaptan concentrations were determined by titration. It was found that the first order mercaptan oxidation rate constant was 0.041 min⁻¹.

### Example 3

In this Example, a catalytic propylene fiber was prepared and evaluated. A 11.80 gram multifilament polypropylene yarn was soaked in a 2 wt. % potassium chlorate (KClO₃) and 28 wt. % sulfuric acid solution at room temperature for 2 hours to produce potassium chlorate treated polypropylene fiber. The potassium chlorate treated polypropylene fiber was washed with DI water and dried in an oven at 60° C. Next, 0.4 grams of mono-amino cobalt phthalocyanine were dissolved in 175 m DMSO. A 11.80 gram aliquot of potassium chlorate treated polypropylene fiber was added to the mono-amino cobalt phthalocyanine solution and heated at 117° C. for 15 hours to graft the mono-amino cobalt phthalocyanine to the potassium chlorate treated polypropylene fiber to produce catalytic polypropylene fiber. The catalytic polypropylene fiber as washed with DMSO and DI water followed by drying in an oven at 60° C.

The mercaptan oxidation performance of the catalytic polypropylene fiber was evaluated in a packed bed reactor. Kerosene containing about 350 ppm mercaptan was used as a feed to the packed bed reactor. The packed bed reactor was operated at 38° C. with a 2.6 minute residence time. At these conditions, it was observed that 64% of the mercaptan in the feed was removed.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are discussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be incorporated herein by reference, the definitions that are consistent with this specification should be adopted.

What is claimed is:

1. A method of producing a functional polymer comprising:
providing a polymer comprising carboxyl groups on a surface of the polymer and a macrocycle comprising an amine on a surface of the macrocycle;
mixing the polymer and the macrocycle; and
reacting the polymer and the macrocycle to form an amide bond between the polymer and the macrocycle thereby forming the functional polymer.

2. The method of claim 1 wherein the polymer comprises one or more polymers selected from the group consisting of polysaccharides, polyisoprenes, polyamides, aromatic polyamides, polyesters, polyolefins, polychloroprenes, polybutadienes, butyl rubber, styrene butadiene rubber, nitrile rubber, and combinations thereof.

3. The method of claim 1 wherein the polymer comprises one or more polymers selected form the group consisting of cellulose, natural rubber, wool, polyester, polyethylene, polypropylene, polystyrene, neoprene, nylon, and combinations thereof.

4. The method of claim 1 wherein the macrocycle comprises one or more macrocycles selected from the group consisting of porphyrin and derivatives thereof, phthalocyanine macrocycles and derivatives thereof, crown ethers and derivatives thereof, aza substituted crown ethers and derivatives thereof, polyaza macrocycles and derivatives thereof, polythia macrocycles and derivatives thereof, polyphospha macrocycles and derivatives thereof, polypyridone macrocycles and derivatives thereof, and combinations thereof.

5. The method of claim 1 wherein the macrocycle comprises one or more macrocycles selected from the group consisting of mono and/or poly amino metal phthalocyanines, mono and/or poly carboxyl metal phthalocyanines, macrocyclic pyridone pentamer, cyclam, aminobenzo-18-crown-6,2-aminomethyl-18-crown-6, combinations thereof.

6. The method of claim 1 wherein the macrocycle comprises one or more structures selected from the group consisting of: 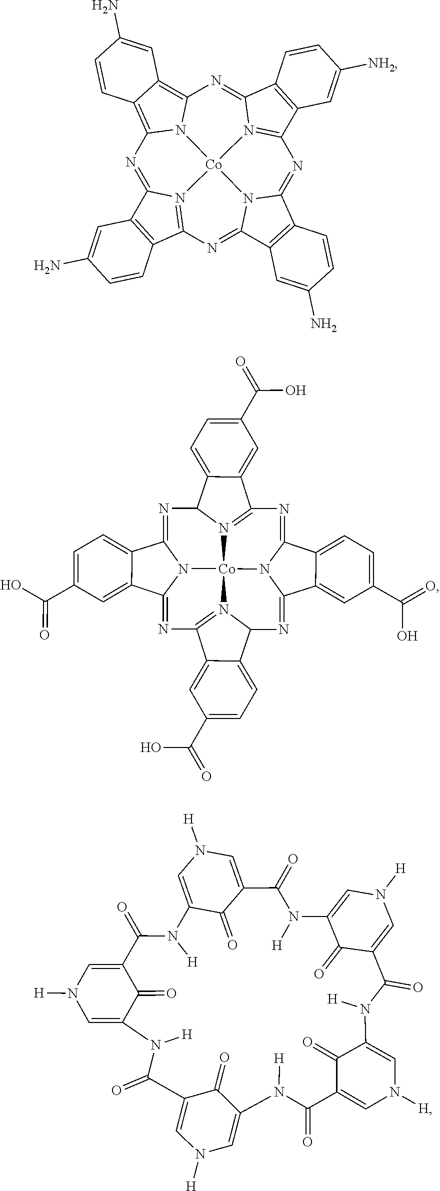 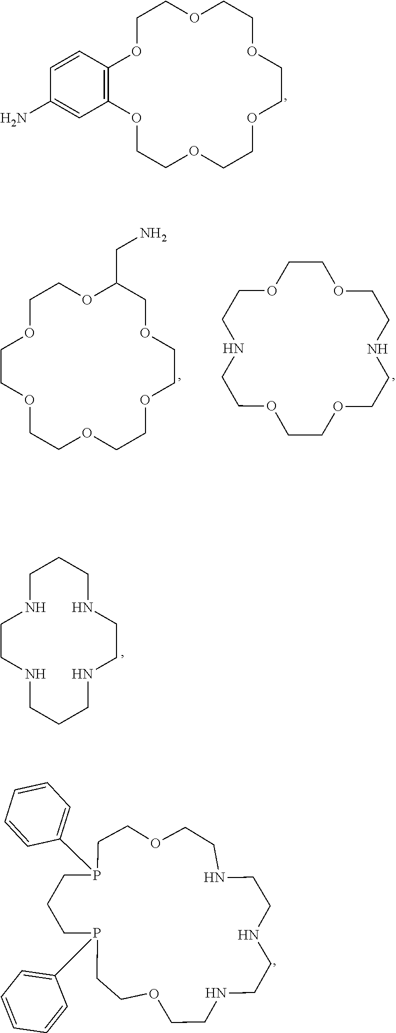 [SMILES: Nc1ccc2c(c1)OCCOCCOCCOCCOCCO2 ; NCC1COCCOCCOCCOCCOCCO1 ; C1COCCOCCNCCOCCOCCN1 ; C1CNCCNCCCNCCNC1 ; c1ccc(P2CCCP(c3ccccc3)CCOCCNCCNCCNCCOCC2)cc1]
and combinations thereof.

7. The method of claim 1 further comprising mixing the polymer and the macrocycle in a solvent and heating the solvent to a temperature sufficient to react the polymer and the macrocycle.

8. The method of claim 7 wherein the solvent comprises at least one solvent selected from the group consisting of water, pyridine, DMSO, DMF, THF, ethanol, acetonitrile, chloroform, ethylene glycol, methanol, benzene, and combinations thereof.

9. The method of claim 1 further comprising:
reacting the polymer with a chlorinating agent to produce a polymer comprising acyl chloride; and
reacting the polymer comprising acyl chloride and the macrocycle.

10. The method of claim 9 wherein the chlorinating agent comprises at least one chlorinating agent selected from the group consisting of thionyl chloride, phosphorous trichloride, terephthaloyl chloride, and combinations thereof.

11. The method of claim 1 further comprising:
reacting the polymer with a coupling agent to produce a coupling agent modified polymer; and
reacting the coupling agent modified polymer with the macrocycle.

12. The method of claim 11 wherein the coupling agent comprises at least one coupling agent selected from the group consisting of carbodiimide, benzotriazole, and combinations thereof.

13. The method of claim 1 further comprising:
providing an enzyme capable of catalyzing the amide bond formation; and
reacting the polymer with the macrocycle in the presence of the enzyme to form the amide bond.

14. The method of claim 13 wherein the enzyme comprises one or more enzymes selected from the group consisting of proteases, subtilisin, acylases, amidases lipases, and combinations thereof.

15. The method of claim 1 further comprising oxidizing a virgin polymer to produce the polymer comprising carboxyl groups.

16. The method of claim 15 wherein oxidizing comprises at least one oxidation process selected from gamma-radiation treatment, plasma treatment, UV treatment, or chemical oxidation.

17. The method of claim 16 wherein chemical oxidation comprises oxidizing with at least one oxidizer selected from hydrochloric acid, nitric acid, phosphoric acid, sulfuric acid, boric acid, hydrofluoric acid, hydrobromic acid, perchloric acid, hydroiodic acid, fluoroantimonic acid, carborane acids, fluoroboric acid, fluorosulfuric acid, hydrogen fluoride, triflic acid, perchloric acid, acetic acid, formic acid, citric acid, oxalic acid, and tartaric acid, ozone, hydrogen peroxide, sodium hypochlorite, permanganate, potassium chromate, potassium dichromate, chlorine dioxide, transition metal nitrates, and combinations thereof.

18. A method of producing a functional polymer comprising:
providing a polymer comprising an amine group on a surface of the polymer and a macrocycle comprising a carboxyl group on a surface of the macrocycle;
mixing the polymer and the macrocycle; and
reacting the polymer and the macrocycle to form an amide bond between the polymer and the macrocycle thereby forming the functional polymer.

19. A method comprising:
introducing into a fiber bundle contactor a hydrocarbon comprising mercaptan sulfur, an aqueous caustic solution, and an oxidizer, wherein the fiber bundle contactor comprises a flow path defined by a conduit, a functional polymer disposed in the conduit, and an inlet allowing fluid flow into the flow path, wherein the functional polymer comprises a polymer and a macrocycle grafted to the polymer;
reacting at least a portion of the mercaptan sulfur and the aqueous caustic solution to produce a mercaptide; and
reacting the mercaptide and the oxidizer in the presence of the functional polymer to produce a disulfide oil.

20. The method of claim 19 wherein the polymer comprises one or more polymers selected from the group consisting of polysaccharides, polyisoprenes, polyamides, aromatic polyamides, polyesters, polyolefins, polychloroprenes, polybutadienes, butyl rubber, styrene butadiene rubber, nitrile rubber, and combinations thereof.

21. The method of claim 19 wherein the macrocycle comprises one or more macrocycles selected from the group consisting of porphyrin and derivatives thereof, phthalocyanine macrocycles and derivatives thereof, crown ethers and derivatives thereof, aza substituted crown ethers and derivatives thereof, polyaza macrocycles and derivatives thereof, polythia macrocycles and derivatives thereof, polyphospha macrocycles and derivatives thereof, polypyridone macrocycles and derivatives thereof, and combinations thereof.

22. A method comprising:
providing a functional polymer comprising a polymer and a macrocycle grafted to the polymer;
contacting the functional polymer with a solution comprising metal ions; and
adsorbing at least a portion of the metal ions with the functional polymer.

23. The method of claim 22 wherein the polymer comprises one or more polymers selected from the group consisting of polysaccharides, polyisoprenes, polyamides, aromatic polyamides, polyesters, polyolefins, polychloroprenes, polybutadienes, butyl rubber, styrene butadiene rubber, nitrile rubber, and combinations thereof.

24. The method of claim 22 wherein the macrocycle comprises one or more macrocycles selected from the group consisting of porphyrin and derivatives thereof, phthalocyanine macrocycles and derivatives thereof, crown ethers and derivatives thereof, aza substituted crown ethers and derivatives thereof, polyaza macrocycles and derivatives thereof, polythia macrocycles and derivatives thereof, polyphospha macrocycles and derivatives thereof, polypyridone macrocycles and derivatives thereof, and combinations thereof.

25. A functional polymer comprising:
a polymer; and
a macrocycle, wherein the macrocycle is grafted to the polymer by an amide bond formed between the macrocycle and the polymer.

26. The functional polymer of claim 25 wherein the polymer comprises one or more polymers selected from the group consisting of polysaccharides, polyisoprenes, polyamides, aromatic polyamides, polyesters, polyolefins, polychloroprenes, polybutadienes, butyl rubber, styrene butadiene rubber, nitrile rubber, and combinations thereof.

27. The functional polymer of claim 25 wherein the macrocycle comprises one or more macrocycles selected from the group consisting of porphyrin and derivatives thereof, phthalocyanine macrocycles and derivatives thereof, crown ethers and derivatives thereof, aza substituted crown ethers and derivatives thereof, polyaza macrocycles and derivatives thereof, polythia macrocycles and derivatives thereof, polyphospha macrocycles and derivatives thereof, polypyridone macrocycles and derivatives thereof, and combinations thereof.

28. An apparatus comprising:
a flow path defined by a conduit; and
a functional polymer disposed in the conduit, wherein the functional polymer comprises a polymer and a macrocycle, wherein the macrocycle is grafted to the polymer by an amide bond formed between the macrocycle and the polymer.

29. The apparatus of claim 28 wherein the polymer comprises one or more polymers selected from the group consisting of polysaccharides, polyisoprenes, polyamides, aromatic polyamides, polyesters, polyolefins, polychloroprenes, polybutadienes, butyl rubber, styrene butadiene rubber, nitrile rubber, and combinations thereof.

30. The apparatus of claim 28 wherein the macrocycle comprises one or more macrocycles selected from the group consisting of porphyrin and derivatives thereof, phthalocyanine macrocycles and derivatives thereof, crown ethers and derivatives thereof, aza substituted crown ethers and derivatives thereof, polyaza macrocycles and derivatives thereof, polythia macrocycles and derivatives thereof, polyphospha macrocycles and derivatives thereof, polypyridone macrocycles and derivatives thereof, and combinations thereof.
